(19) United States
(12) Patent Application Publication
(10) Pub. No.: US 2011/0246402 A1
(43) Pub. Date: Oct. 6, 2011

(54) ACOUSTIC EVENT CLASSIFICATION USING PARTICLE SWARM OPTIMIZATION WITH FLEXIBLE TIME CORRELATION MATCHING

(75) Inventor: JERRY BURMAN, Westlake Village, CA (US)

(73) Assignee: Teledyne Scientific & Imaging, LLC

(21) Appl. No.: 13/049,446

(22) Filed: Mar. 16, 2011

Related U.S. Application Data
(60) Provisional application No. 61/319,657, filed on Mar. 31, 2010.

(51) Int. Cl. G06F 15/18

(52) U.S. Cl. 706/14

(57) ABSTRACT

An acoustic event classifier uses particle swarm optimization (PSO) to perform a flexible time correlation of a sensed acoustic signature to reference acoustic signatures in a multi-dimensional parameter space. The classifier may fuse the acoustic signatures from multiple acoustic sensors to form the sensed acoustic signature. The approach is generally applicable to classify all types of acoustic events but is particularly well-suited to classify “explosive” events such as gun shots, mortar blasts, improvised explosive device blasts etc.

that produce an acoustic signature having a shock wave component that is periodic and non-linear.

### CROSS-REFERENCE TO RELATED APPLICATIONS

This application claims benefit of priority under 35 U.S.C. 119(e) to U.S. Provisional Application No. 61,319,657 entitled “Acoustic Event Classification Using Particle Swarm Optimization with Flexible Time Correlation matching” filed on Mar. 31, 2010 the entire contents of which are incorporated by reference.

### GOVERNMENT RIGHTS

This invention was made with Government support under contract W911NF-09-D-0001 awarded by the US Army Research Office. The Government has certain rights in this invention.

### BACKGROUND OF THE INVENTION

1. Field of the Invention

This invention relates to acoustic event classification and more specifically to the use of particle swarm optimization (PSO) to perform a flexible time correlation of a sensed acoustic signature to reference acoustic signatures in a multi-dimensional parameter space. The approach is generally applicable to classify all types of acoustic events but is particularly well-suited to classify “explosive” events such as gun shots, mortar blasts, improvised explosive device blasts etc. that produce an acoustic signature having a shock wave component that is non-periodic and non-linear.

2. Description of the Related Art

Acoustic event classification relates to the processing of sensed acoustic signatures to classify the underlying acoustic event. There exist many different approaches to the automatic classification of acoustic events based on the processing of the sensed acoustic signature. Known approaches extract different types of features from the acoustic signature and apply the extracted features to a trained classifier to identify the acoustic event. The approaches may differ in one or both of the types of features that are extracted and the classifier architecture. The features may be time-based and/or transform-based (Fast Fourier Transform (FFT), Wavelet etc.). The classifier may be, for example, a Neural Network (NN), a Support Vector Machine (SVM), K-Nearest Neighbors/Hidden Markov model etc.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention relates to acoustic event classification. The approach is generally applicable to classify all types of acoustic events but is particularly well-suited to classify “explosive” events such as gun shots, mortar blasts, improvised explosive device blasts etc. that produce an acoustic signature having a shock wave component that is non-periodic and non-linear.

This is accomplished with the use of particle swarm optimization (PSO) to perform a flexible time correlation of a sensed acoustic signature to reference acoustic signatures in a multi-dimensional parameter space. Particle swarm optimization functions as the classifier to identify the reference acoustic signature that is the best match to the sensed acoustic signature and to output the acoustic event associated with that reference signature.

In an embodiment, a classifier comprises one or more computer processors configured to execute computer program instructions to implement particle swarm optimization (PSO). For each of a plurality of reference acoustic signatures rₙ(t) the classifier initializes a swarm of multiple particles with initial values for a variable gain parameter g and a variable temporal shift parameter β. The classifier iteratively modifies those values based on parameter values found by that particle and other particles in the swarm to fit the reference acoustic signature rₙ(t) to a temporal acoustic signature S(t) comprised of one or more component temporal acoustic signatures sₘ(t) until the swarm converges to final parameter values. The classifier selects the acoustic event associated with the reference acoustic signature rₙ(t) having the best fit to the sensed temporal acoustic signature S(t).

In an embodiment, each particle has a cost function that measures the scaled fit between the reference acoustic signature and the temporal acoustic signature. The gain and temporal shift parameter values that provide the minimum cost function constituting the best-found values. The classifier modifies the gain and temporal shift parameter values for each particle based on the best-found values for that particle and the best-found values for all particles in the swarm through the current iteration. The classifier may further modify the gain and temporal shift parameter values for each particle based on inertia of that particle.

In an embodiment, the acoustic signature S(t) comprises one component temporal acoustic signature s(t) from a single acoustic sensor. Each reference acoustic signature rₙ(t) is represented by a temporal model g*rₙ(εt+β) where rₙ(*) is the n^{th} reference acoustic signature of N and ε is a variable time dilation parameter. rₙ(*) may, for example, be modeled as a spline, polynomial or Gabor function and may include one or more “knots” to create a piecewise model. The classifier uses PSO to scale the temporal model according to the gain, shift and time dilation parameter values to fit the model to the temporal acoustic signature S(t). The classifier selects the acoustic event associated with the model that provides the best fit to the acoustic signature.

In an embodiment, the classifier fuses the component temporal acoustic signatures sₘ(t) from a plurality of acoustic signatures to form the temporal acoustic signature S(t)=Σgₘ*sₘ(t-βₘ) over M component signatures in which each component temporal acoustic signature sₘ(t) is scaled by a variable gain parameter gₘ and a variable temporal shift parameter βₘ. The classifier uses PSO to scale the temporal acoustic signature S(t) according to the gain and temporal shift parameter values for each of the component signatures to fit S(t) to the reference acoustic signature rₙ(t). The classifier selects the acoustic event whose reference acoustic signature provides the best fit to the acoustic signature.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is an illustration of a network of unattended ground sensors in a battlefield environment for providing situational awareness including the classification of acoustic events;

FIGS. 2a through 2c are an illustration of an explosive-type acoustic event that produces a periodic non-linear acoustic signature including shock wave and blast wave components;

FIGS. 3a and 3b are illustrations of the shock wave for a gunshot and a mortar explosion, respectively;

FIG. 4 is a block diagram of an embodiment of an acoustic event classifier using particle swarm optimization to classify an acoustic event based on the sensed acoustic signature from a single acoustic sensor in accordance with the present invention;

FIG. 5 is a flow diagram of the use of particle swarm optimization to perform a flexible time correlation of a sensed acoustic signature from a single acoustic sensor to temporal models of reference signatures in a multi-dimensional parameter space (g, ε, β);

FIGS. 6a and 6b are two different depictions illustrating swarm convergence;

FIGS. 7a-7b are a sequence of diagrams illustrating the convergence of a reference signature in the multi-dimensional parameter space (g, ε, β) to the sensed signature for a mortal explosion using particle swarm optimization;

FIG. 8 is a table of preliminary results for various types of discrete acoustic events in which one event was used as the reference;

FIG. 9 is a diagram of an embodiment of a system in which a network of acoustic sensors report component sensed acoustic signatures to a central processing node that uses PSO to classify acoustic events;

FIG. 10 is a plot of the acoustic signatures reported by the different acoustic signatures in response to a common acoustic event;

FIG. 11 is a block diagram of an embodiment of an acoustic event classifier using particle swarm optimization to classify an acoustic event based on the fused acoustic signature from multiple acoustic sensors in accordance with the present invention; and

FIGS. 12a and 12b are diagrams of the optimized gain and time delay parameters for the components of the fused acoustic signature and the best fit of the fused acoustic signature to the reference acoustic signature associated with the acoustic event.

### DETAILED DESCRIPTION OF THE INVENTION

Acoustic event classification may occur for a variety of different applications in many different environments and different types of acoustic events. The present invention is sufficiently robust to classify all kinds of acoustic events in different environments.

Without loss of generality, an embodiment of the invention will be described in the context of a network of unattended ground sensors (UGSs) that sense acoustic signatures of terrestrial events to provide situational awareness to dismounted troops and upper echelons in support of the mission and operations. Accurate classification of the acoustic events is an important component of situational awareness.

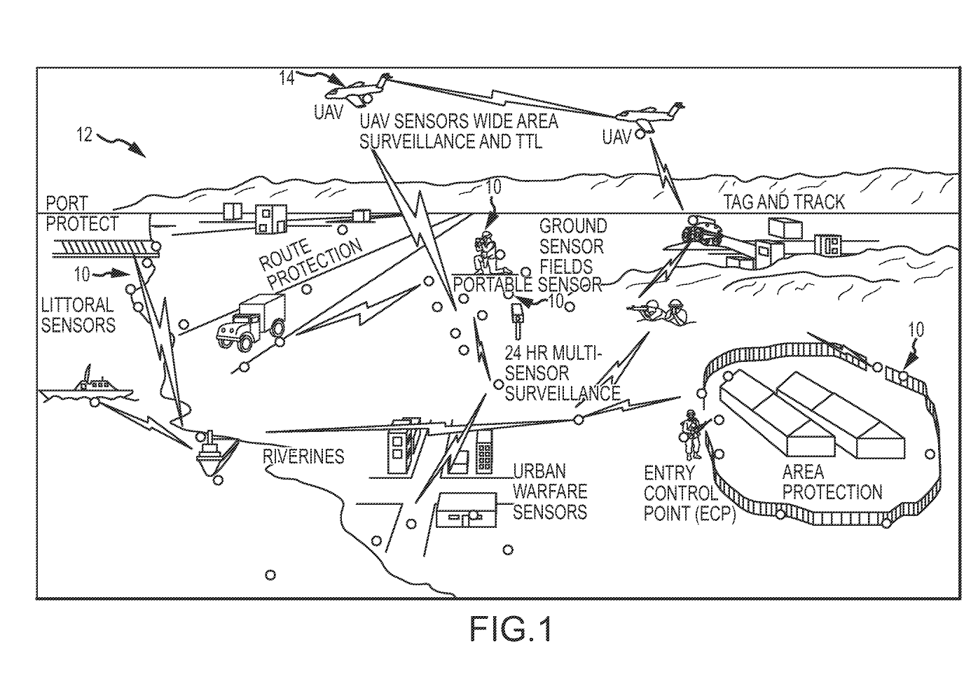

A high level depiction of the deployment and interaction of unattended ground sensors (UGSs) 10 in a battle space 12 is shown in FIG. 1. Each UGS may comprise a transducer that senses sound pressure and converts the pressure level to an electrical signal. An analog-to-digital (A/D) converter produces a digital acoustic signature referred to as the sensed signal. Each UGS may further comprise other types of sensors. In this scenario, a sparse network of collectors (UAVs) 14 are employed to capture and disseminate information gathered from the UGS 10 to dismounted soldiers 16 and local area echelons to provide situational awareness of the battle space.

For purposes of acoustic event classification, the acoustic signatures from UGSs 10 may be classified independently, classified independently and the classification results fused together or the signatures may be fused and then applied to the classifier. The classifier may be implemented by a combination of one or more computer processors and computer memory and software implemented on the processors and computer memory. The classifier may, for example, be implemented in each of the UGSs 10, one or more control UGSs 10 that are designated as central processing nodes (for example, a control node processes raw data from UGSs and uplinks information to the UAV), a central processing node that is not a sensor, the UAV 10, a base station or at the recipient of the information.

In this scenario, the classifier may be asked to classify acoustic events associated with motorized land vehicles (e.g. civilian cars, jeeps, tanks, etc), ships (e.g. small commercial boats, larger military ships), the report of weapons (e.g. gunshots, mortar explosions, improvised explosive device (IED) explosions, conventional explosives etc.). Acoustic events and the acoustic signatures they produce may be roughly classified as continuous, burst, or explosive. A “continuous” event produces a continuous sustained amplitude. An example might be the acoustic signature produced by the motor of a vehicle. A “burst” event produces an amplitude that rises sharply and decays gradually. A “sudden acceleration of a jet engine” would produce a burst type event with amplitude decay. An “explosive” event produces an amplitude that rises sharply and decays rapidly. An explosive event produces a shock wave component and may produce a trailing blast wave component. Each of these components may have only a single or a couple “zero-crossing” whereas a burst event will have multiple zero-crossings as it decays gradually. Gunshots, mortar explosions, IEDs and other explosive detonations are examples of explosive events.

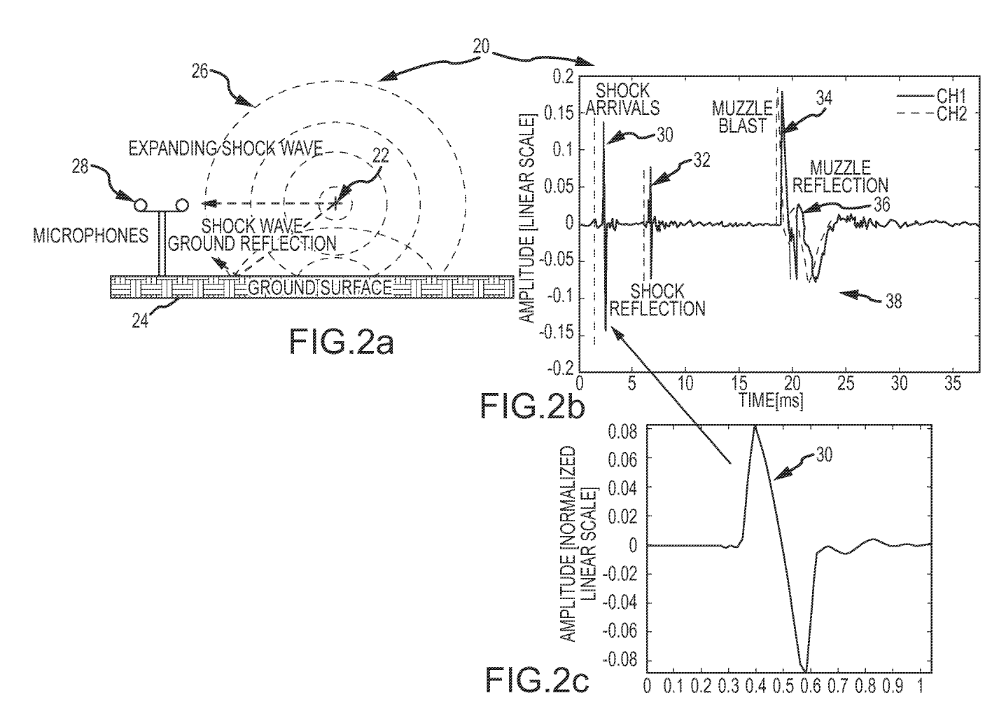

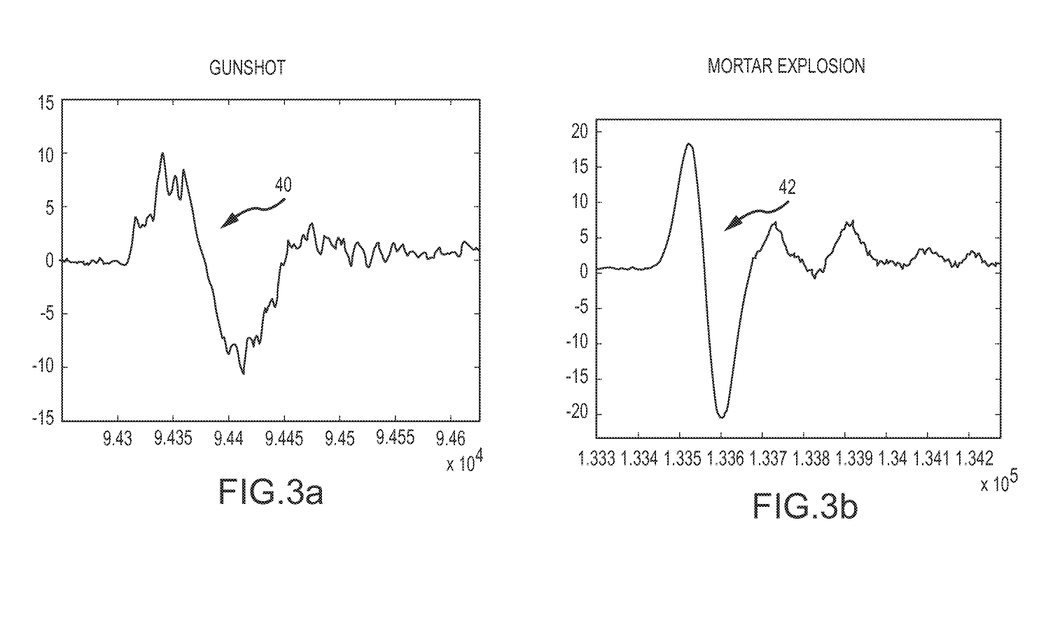

An “explosive” event 20 is depicted in FIGS. 2a through 2c. A gunshot 22 is fired parallel to the ground surface 24 into the page. The gunshot 22 produces a pressure wave 26 that is detected by a pair of microphones 28 (e.g. an acoustic sensor). The explosive event may comprise multiple sub-events including a shock arrival 30 (e.g. pressure wave created by detonation of the gun powder), shock reflection 32 (shock wave reflected off of the ground surface travels a longer path and is delayed a few milliseconds), a muzzle blast 34 (e.g. the blast wave caused by the bullet being propelled out of the gun barrel) and a muzzle reflection 36 (muzzle blast reflected off of the ground surface). These discrete sub-events are reflected in the sensed acoustic signature 38. The signature is shown for each channel (microphone) exhibiting a small time shift. The acoustic signature of the explosive event is non-periodic and non-linear. As shown in FIG. 2c, shock arrival 30 may be characterized by a rapidly rising amplitude and rapidly falling amplitude. In this particular case, the amplitude exhibits a single zero crossing. The acoustic signatures for other explosive events would be similar. FIGS. 3a and 3b are plots of the shock wave components for a gunshot 40 and a mortar explosion 42, respectively. The time-based signatures are highly non-periodic, non-linear and quite similar. If variants of the acoustic signatures were shown over time dilation (e.g. due to Doppler shift), time shift (e.g. due to distance to sensors) and gain (e.g. amplitude of the pressure wave) the difficulty of the classification problem would be more evident.

In general, it is difficult to develop a reliable acoustic event classifier based on traditional feature extraction and classification because of the difficulty in determining subtle differences between specific types of events. The subtle variations in acoustic signatures are primarily due to variations in the geometry associated with the event location; the terrain topology, multi-path/reflections and environmental effects (e.g. temperature). Traditional feature extraction and classification generally assume that the underlying features are time or space invariant so that decision boundaries can be formed through training Furthermore a large number of exemplars are typically required to train the classifiers. Moreover, the underlying basis functions used with traditional classification methods (e.g. Fourier, wavelet, etc.) may have little to do with the nature of the underlying event. These basis functions are periodic and thus do not represent the non-periodic non-linear structure of the acoustic signature associated with, for example, explosive events.

A process is defined that permits a flexible comparison or correlation of similar or disparate temporal signatures for the purpose of classifying data obtained from one or more acoustic sensors into one of several possible categories. The process employs a bio-inspired strategy to perform the comparison based on a best-fit criterion. A database of reference signatures (exemplars) is utilized to define the domain of possible events and types of categories for classification. The process attempts to answer a hypothesis test to classify an event based on the degree of match between sensed data and a modified representation of the reference signatures (or vice-versa) determined by bio-inspired processing. A confidence level is determined and used to find the best match between the reference database and the sensed signature and results in a sensed signature being classified according to the domain of the reference database. If a sufficient match is not achieved between the sensed and reference signatures based on the level of confidence, the signature is declared as unknown relative to the domain of possible events

The bio-inspired process used to compare sensed and reference data is based on a method used for search optimization commonly referred to as Particle Swarm Optimization (PSO). An artificial swarm is created in computer memory and used to adjust the parameters of the reference (sensed) signatures for comparison to the sensed data (reference signatures). The swarm is modeled using a discrete set of difference equations; the equations are coupled to represent a loose form of feedback between search agents in the swarm. The swarm adjusts the parameters in a fashion similar to how insects (e.g. honey bees) search to find someone who disturbs their hive. The sensed and reference signatures are then compared to achieve classification of the sensed data. Classification is achieved when the swarm converges to an optimal set of parameters associated with the global minimum of a cost function. The swarm dynamics avoids local minima in searching the cost function through the use of multiple agents who attempt to locate the global minimum of a cost function that compares the signatures over their temporal extent.

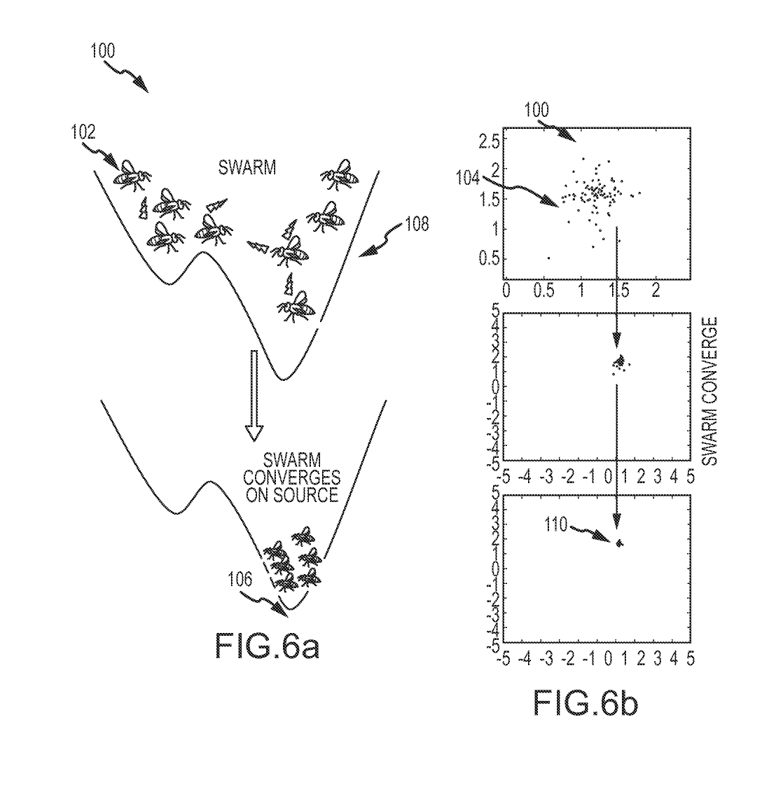

An important feature of the search for the global minimum of the cost function (classification of a sensed signature) is the communication or feedback between the agents as manifested through the coupling of the discrete equations that model swarm dynamics. The communication or agent feedback facilitates how the agents avoid local minima as a large number of agents search the feature space to find the minimum cost value. If a subgroup of agents gets trapped in a local minimum, the other agents who are also searching in a parallel fashion may find lower cost features and will communicate that data to the agents who are trapped in local minima. The feedback between agents thereby forces the trapped agents out of the local minima to continue to search for the global minimum of the cost function. When the global minimum is found, all agents follow and converge in the search for the optimal feature values (FIGS. 6a and 6b).

In accordance with the invention, an acoustic event classifier uses particle swarm optimization (PSO) to perform a flexible time correlation of a sensed acoustic signature to reference acoustic signatures in a multi-dimensional parameter space (e.g. g, ε, β). Particle swarm optimization functions as the classifier to identify the reference signature and parameters that are the best match to the sensed acoustic signature and to output the acoustic event associated with that class or category of reference signature. This classifier performs a direct flexible time-correlation to the sensed acoustic signal to answer a specific hypothesis without using feature extraction or assumption of invariance.

In an embodiment, the sensed acoustic signatures are classified independently. PSO may be used to scale either the reference acoustic signature or the sensed acoustic signature to identify the best fit and classify the acoustic event. Scaling the reference acoustic signature has the benefit that the reference signature can be modeled off-line with a function that incorporates time shift, time dilation and gain parameters and may be based on a single exemplar. The reference signatures are modeled using known techniques so that they can be represented as functions of time; in this way, the parameters consisting of gain, time dilation and temporal shift can be modified by the bio-inspired process as part of the correlation process. Splines may be used to model the reference signatures as functions of time; other modeling techniques are possible (e.g. polynomials, Gabor functions, etc.). The parameters of the splines are modified over time by an underlying bio-inspired process to find the best match or minimum of a cost function that compares the signatures over their temporal extent.

In another embodiment, the sensed acoustic signatures are fused together and classified. PSO is used to scale the components of the fused signature to identify the best fit to a reference signature and classify the acoustic event.

James Kennedy and Russell Eberhart “Particle Swarm Optimization” Proceedings of IEEE International Conference on Neural Networks, vol. 4, Perth, Australia, 1995; 1942-1948, which is hereby incorporated by reference, first introduced the concept for the optimization of nonlinear functions using particle swarm methodology. Over the past 15 years, PSO has been applied to many applications including but not limited to telecommunications, data mining, control, design, combinatorial optimization, power systems, signal processing, and many others. PSO has been studied for clustering and classification problems including clustering, clustering in large spatial databases, dynamic clustering, dimensionality reduction, genetic-programming-based classification, fuzzy clustering, cascading classifiers, classification threshold optimization, classification of hierarchical biological data, electrical wafer sort classification, document and information clustering, data mining, feature selection (Analysis of the Publications on the Applications of Particle Swarm Optimization, Riccardo Poli, Journal of Artificial Evolution and Applications, Volume 2008). As regards classification, PSO has been used to train Neural Networks and Support Vector Machines to form the decision boundaries.

In accordance with the present invention, PSO is used as the classifier. PSO is being used to answer a specific hypothesis and does not assume that the representation is invariant. In general, the hypothesis is that a sensed waveform s(t) may be represented over time by a reference signature rₙ(t) by scaling either the sensed waveform or the reference signature in a multidimensional parameter space including at least gain and temporal shift and possibly time dilation. In an embodiment of independent classification, the hypothesis is that a sensed waveform s(t) can be represented over time by a variation of a reference signature rₙ(*) in terms of gain, time dilation and temporal shift as g*rₙ(εt+β). In an embodiment of fused classification, the hypothesis is that a reference signature rₙ(t) can be represented over time by a variation of a fused acoustic signature S(t)=Σgₘ*sₘ(t-βₘ) over M sensed signatures in terms of gain and temporal shift.

Given that we were using PSO as the classifier and not merely to train the classifier, it was initially unknown whether PSO would converge to a solution, would converge to a global optimum solution and would converge quickly for either independent or fused classification. It was not until the PSO classifier was implemented and tested on real data and found to perform very well were we convinced of the viability of PSO for direct classification.

To implement our classifier, one needs to estimate the three parameters (g, ε, β) for independent classification or two parameters (g, β) for each component for fused classification in order to compare or correlate a stored reference signature representative of an event of interest to sensed data. Metrics for comparison of reference and sensed signatures include the mean squared distance between the two waveforms given an optimal choice of the parameters. Other metrics for comparison and classification are possible including the correlation coefficient that compares the sensed data with the database of reference signatures.

### Independent Classification

Considering independent classification, the signature comparison process resolves an hypothesis test and suggests that one needs to model the reference signatures and then to try and optimize the parameter settings so that the mean squared distance (cost function) between the (modified) reference and sensed signature are as close as possible over the extent of the temporal event. Consequently, the strategy adopted for event classification is to model the reference signature using splines (or other time-based functions such as polynomials or Gabor functions) and then to adjust the three parameters (g, ε, β) associated with the reference signature modeled by the splines to minimize the cost function during the signature comparison or correlation process.

Once the sensed signature is accurately modeled as a function of time, the three parameters (g, ε, β) can be adjusted using a search technique to minimize the cost function. One technique that has proven to be robust in terms of parameter search is based on a bio-inspired concept related to swarm optimization. The dynamics of the swarm are modeled as a coupled system of discrete equations where the coupling is associated with a loose form of communication between agents in the swarm.

The use of PSO to perform a flexible time correlation to classify the acoustic event exhibits a number of desirable features and benefits. The PSO classifier may exhibit one or more of the following features: handles non-linear/non-periodic signatures, may use a single exemplar representation for class of events thereby avoiding feature extraction, very robust to noise, handles Doppler affects (time dilation), discriminates between highly similar events, operates on sub-feature data, fast implementation and high accuracy with low false alarms. The PSO classifier may provide one or more of the following benefits: robust to a wide range of acoustic signatures, no training required (single reference), tolerant to amplitude and signal variations, can accommodate signatures generated from multiple angles to observer, fine level within class discrimination, requires only partial signature to classify event and may be implemented on UAV, UGS or at a remote base station.

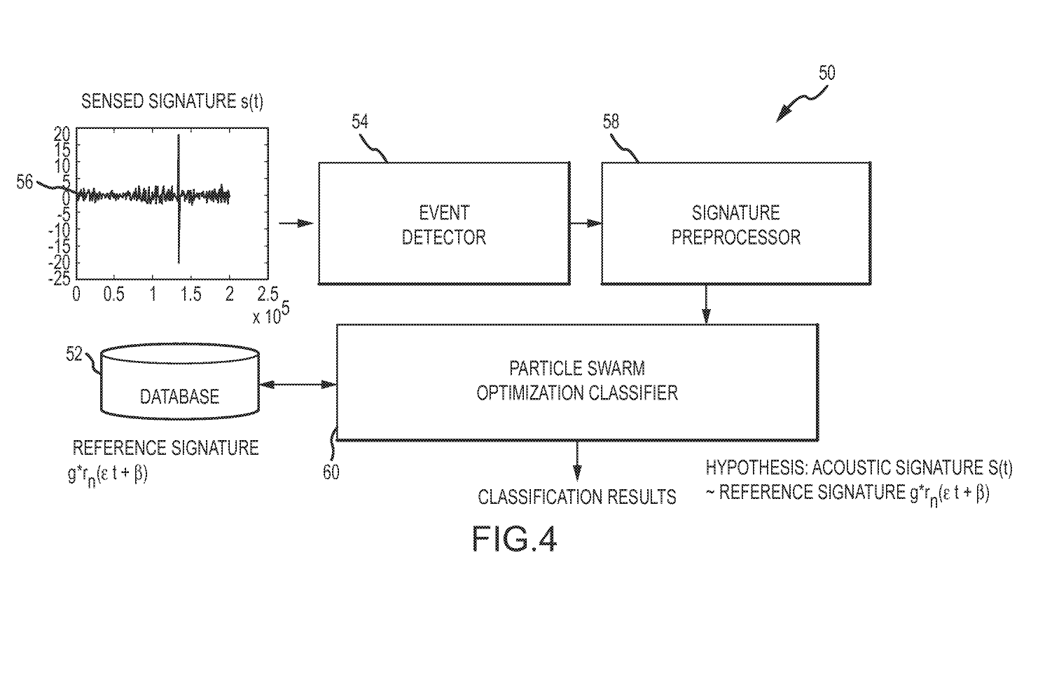

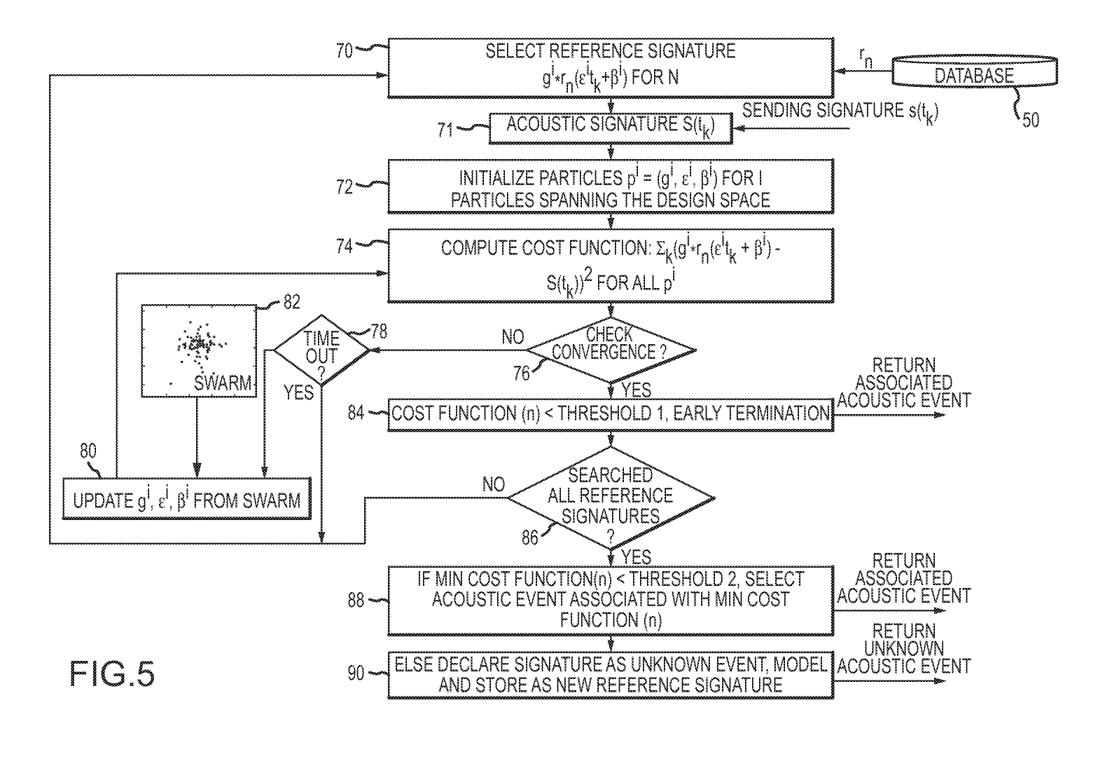

As shown in FIG. 4, an embodiment of an acoustic event classifier 50 comprises a database 52 of reference acoustic signatures associated with different acoustic events, each reference acoustic signature is represented by a temporal model g*rₙ(εt+β) where rₙ(*) is the n^{th} reference acoustic signature and g is gain, ε is time dilation and β is temporal shift. rₙ(*) may, for example, be modeled by a time function such as a spline, polynomial or Gabor function and may include one or more “knots” to construct a piecewise function. An acoustic event detector 54 monitors a sensed temporal acoustic signature s(t) 56 to detect events. The detector may, for example, estimate the energy (variance of a segment of the temporal acoustic signature of short time segments ˜10-20 msec) and compare the energy value to a threshold; if the energy exceeds the threshold, then an event is detected and stored in memory.

Upon detection of an event, a signature preprocessor 58 windows out that portion of the digitized temporal acoustic signal s(t) about the event time. A classifier 60 comprised of one or more computer processors configured to implement particle swarm optimization (PSO) uses PSO to minimize a cost function expressed as an error between an acoustic signature S(t), which in the case of a single sensor is the temporal acoustic signature s(t), and the temporal model g*rₙ(εt+β) modified according to the parameters (g, ε, β) for a reference acoustic signature rₙ(*). PSO initializes the values of parameters (g′, ε¹, β¹) for a large number of “particles” or “swarm agents” pⁱ, typically more than 100, to span the feature space. The particles' positions xⁱ and velocities vⁱ are modified based on knowledge of the best solution found thus far for each particle in the swarm. This process is repeated until the swarm converges to a set of parameters (g, ε, β) with minimum cost function value. The entire process may be repeated for other reference signatures. The classifier selects the acoustic event that produces the minimum cost function (that also satisfies a threshold) and classifies the sensed temporal acoustic signature S(t) as a particular acoustic event “n” (e.g. gunshot, mortar explosion, IED explosion etc.) according to that reference acoustic signature. If the reference signature corresponds to an acoustic event that is not the same as the event that produces the sensed acoustic signature, either the swarm will converge to a result that is not that good compared to the correct reference signature (e.g. a greater cost function) or the swarm may fail to converge all together or very slowly.

Particle swarm optimization is a class of derivative-free, population-based computational methods introduced by Kennedy and Eberhart in 1995. Particles pⁱ or “swarm agents” as they are sometimes referred to are distributed throughout the design space and their positions and velocities are modified based on knowledge of the best solution found thus far by each particle in the ‘swarm’. Attraction towards the best-found solution occurs stochastically and uses dynamically adjusted particle velocities. Particle positions (Equation (1)) and velocities (Equation (2)) are updated as shown below

[symbol]

where xⁱₖ represents the current position of particle i in design space and subscript k indicates a (unit) pseudo-time increment. Equations 1 and 2 represent a coupled set of difference equations where the coupling models agent feedback. The point pⁱₖ is the best-found position of particle i up to time step k and represents the cognitive contribution to the search velocity vⁱₖ. The point p^{g}ₖis the global best-found position among all particles in the swarm up to time step k and forms the social contribution to the velocity vector. The variable wₖ is the particle inertia, which is reduced dynamically to decrease the search area in a gradual fashion. In an alternate embodiment, wₖ may be replaced with a fixed constant (e.g. 0.5). Testing revealed that the use of a fixed constant increased the rate of convergence. Random numbers r₁ and r₂ are uniformly distributed in the interval [0, 1] while c₁ and c₂ are the cognitive and social scaling parameters, respectively. These terms may be the same or different for each of the optimized parameters. In other embodiments, other constants may be modified as well although some amount of random behavior is desirable so that the “swarm agents” search the parameter space in a broad but constrained manner to ensure convergence to a global minimum. Additional details of PSO are provided in: (1) Fourie P C, Groenwold A A. The particle swarm algorithm in size and shape optimization Struct Multidisc Optim 23, 259-267, 2002; (2) Schutte J F, Reinbolt J A, Fregly B J, Haftka R T, George A D. Parallel global optimization with particle swarm algorithm. International Journal for Numerical Methods in Engineering 2003; 1-24 and (3) Byung-Il Koh, George, A. D., Parallel asynchronous particle swarm optimization, Intl. Jour for Numerical Methods in Engr, 2006, 67:578-595, which are each hereby incorporated by reference.

In an embodiment, the acoustic events may comprise any acoustic events including but not limited to continuous, burst or explosive events. The event may produce a non-periodic and non-linear acoustic signature. An explosive event may produce a signature including a shock component and possibly a lagging blast component of the type shown in FIG. 2b. The classifier may be configured to model and match only the shock component, the shock and blast components as separate signatures or the shock and blast components as a single signature.

In an embodiment, the database 52 of reference acoustic signatures may be formed from one or more exemplars of the sensed acoustic signature, a single exemplar being sufficient to form the model. The database may use functions of time such as Splines, Polynomials, Gabor Functions etc. to model the periodic non-linear acoustic signature. Each model may be represented as g*rₙ(εt+β) where rₙ(*) is the n^{th} reference acoustic signature and g is gain, ε is time dilation and β is temporal shift. For example, a piecewise cubic polynomial approach may be used to fit splines to the exemplars. The number and placement of “knots” between splines may be set based on empirically data, a known algorithm for knot placement or possibly using PSO.

An illustrative embodiment of PSO applied to acoustic event classification is shown in FIGS. 5 and 6a and 6b. The classifier selects a first reference signature rₙ(*) (step 70) from database 50 of N reference signatures and receives a single sensed signature s(tₖ) that constitutes the acoustic signature S(tₖ) (step 71). The classifier initializes a swarm of particles pⁱ=(gⁱ, εⁱ, βⁱ) for i=1 to I where I is the number of particles in the swarm (step 72). Values for gⁱ, εⁱ, βⁱ are selected in a manner that ensures that the swarm of particles span the design space. This is important to guarantee convergence to a global minimum. The classifier computes a cost function (step 74) (e.g. mean square error (mse) Σₖ(gⁱ*rₙ(εⁱtₖ+βⁱ)−S(tₖ))²) over time increment k for each particle i between the scaled reference signature and the acoustic signature S(tₖ). Other cost functions such as correlation coefficients, absolute error etc. may be used as well.

The classifier performs a convergence check (step 76). This check looks to see if, for example, the cost function has remained stable over a certain number of iterations. The check could consider the stability of the particles' positions directly to see if they have remained stable or not. This is a different calculation but is essentially embedded in the computation of the cost function. If convergence has not been reached, the classifier may check to see if the algorithm has timed out (step 78), e.g. has the number of iterations exceeded a maximum to find a solution. If the classifier is attempting to match the wrong reference signature to the sensed acoustic signature it is possible that PSO will not converge to a stable solution. Assuming the algorithm has not timed out, the classifier updates the position and velocities (step 80) of the swarm of particles 82 according to equations 1 and 2 above. These positions and velocities are defined in (g, ε, β) space. The classifier repeats steps 74, 76, 78 and 80 until the swarm has converged to a solution or timed out.

The classifier may check to see if the cost function for a given reference signature is less than a first threshold (step 84) and if so opt for early termination and return the associated acoustic event. This first threshold is set to a relatively small value to ensure that any reference signature that satisfies the test is the correct acoustic event and that false alarms are minimized.

Assuming the condition is not met, the classifier checks to see if all the reference signatures have been searched (step 86). If not, the classifier selects a next reference signature in step 70 and repeats the entire process to find the parameters that provide the best fit to the acoustic signature S(t). The classifier continues to iterate until either the early termination condition is satisfied or all of the reference signatures have been searched. The classifier now determines whether the minimum cost function is less than a second threshold (higher than the first threshold) and if yes selects the acoustic event associated with the reference signature that produced the minimum cost function (step 88). If the minimum cost function is not good enough (based on setting the thresholds to maximize the probability of detection and to minimize the false alarm rate), the classifier declares the signature s(t) represents an unknown event (step 90). The classifier may build and store a model for this “unknown event” for future classification. If the source of the unknown event is determined the database may be updated to reflect the source of the acoustic event.

FIGS. 6a and 6b provide different illustrations of how the artificial swarm 100 (shown in FIG. 6a as honey bees 102 and in FIG. 6b as particles 104) can locate the global minimum 106 of a cost function 108 that contains local minima caused by environmental and terrain effects and converge to point 110. This process is similar to how honeybees swarm to converge on a person who upsets their hive; in this case, the artificial swarm converges to find the optimal values (minimum of the cost function) for the parameters (g, ε, β) to solve the classification problem. Convergence of the swarm is generally much more robust than convergence of a single agent using traditional “gradient descent” algorithms. For problems such as providing real-time situational awareness in a battlefield rapid convergence to the global minimum is imperative. This performance is provided by the use of PSO to perform a flexible time correlation. The classification algorithm can be implemented on field-programmable-gate array (FPGA) to achieve sub-second classification performance.

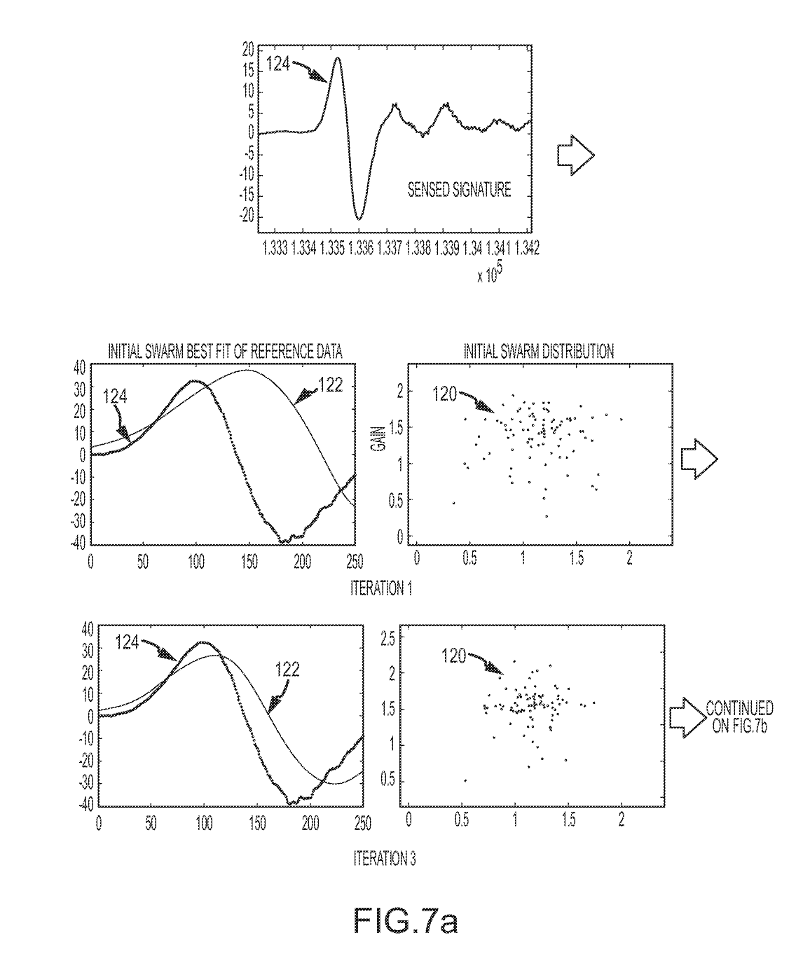

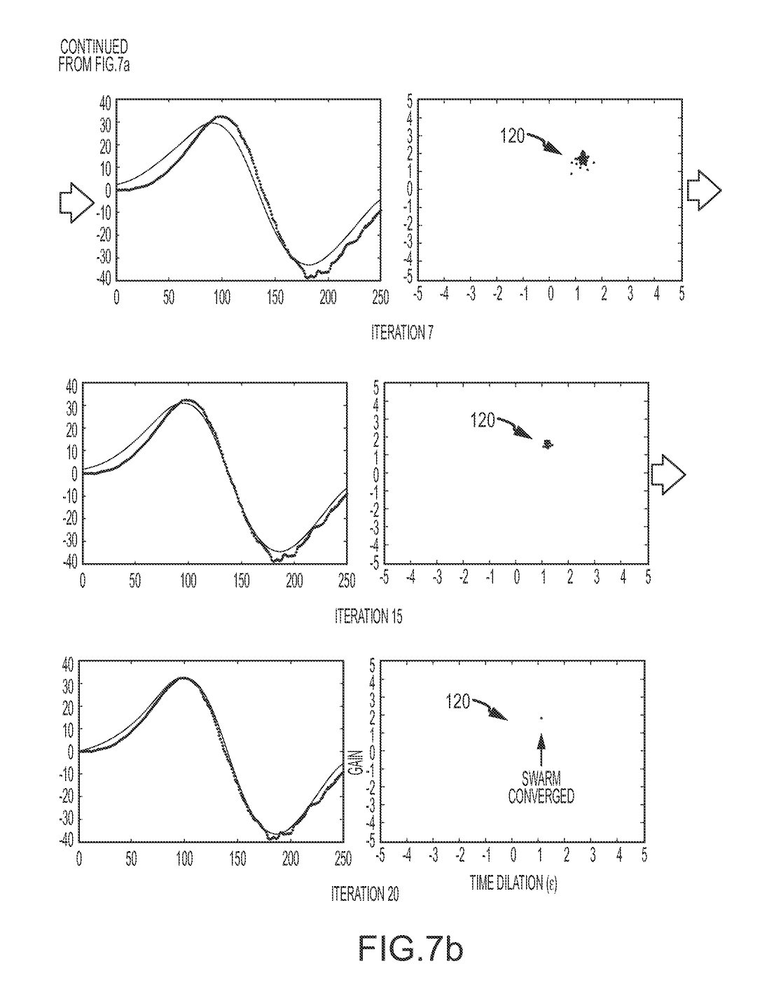

FIGS. 7a and 7b provide an illustration of how the artificial swarm 120 and the best intermediate fit of the reference signature 122 converge to sensed signature 124. As the swarm converges, the best-fit reference signature 122 gets closer and closer to sensed signature 124. After twenty iterations the swarm has collapsed to a point with a low cost function value.

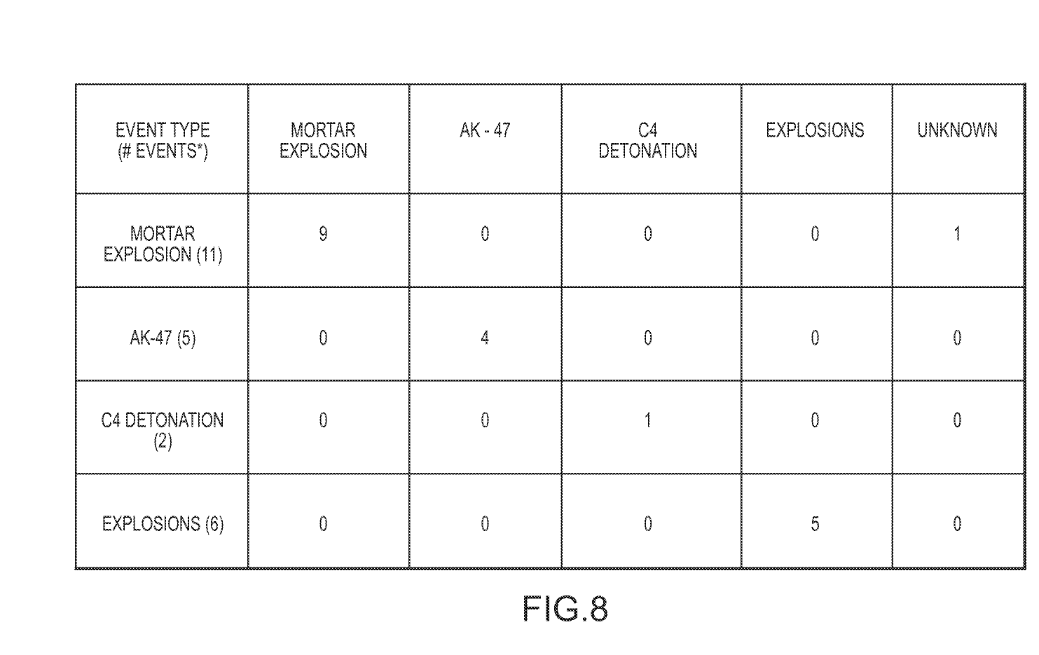

The PSO acoustic classifier was applied to a small database of signatures (real field data). A single exemplar of raw data was selected at random from each class (e.g. mortar explosion, AK-47, C4 detonation, explosions and unknown) to form the reference database and a test was conducted to classify the remaining events. The results of the event classification study are shown in FIG. 8 and represent 100% classification performance.

### Fused Classification

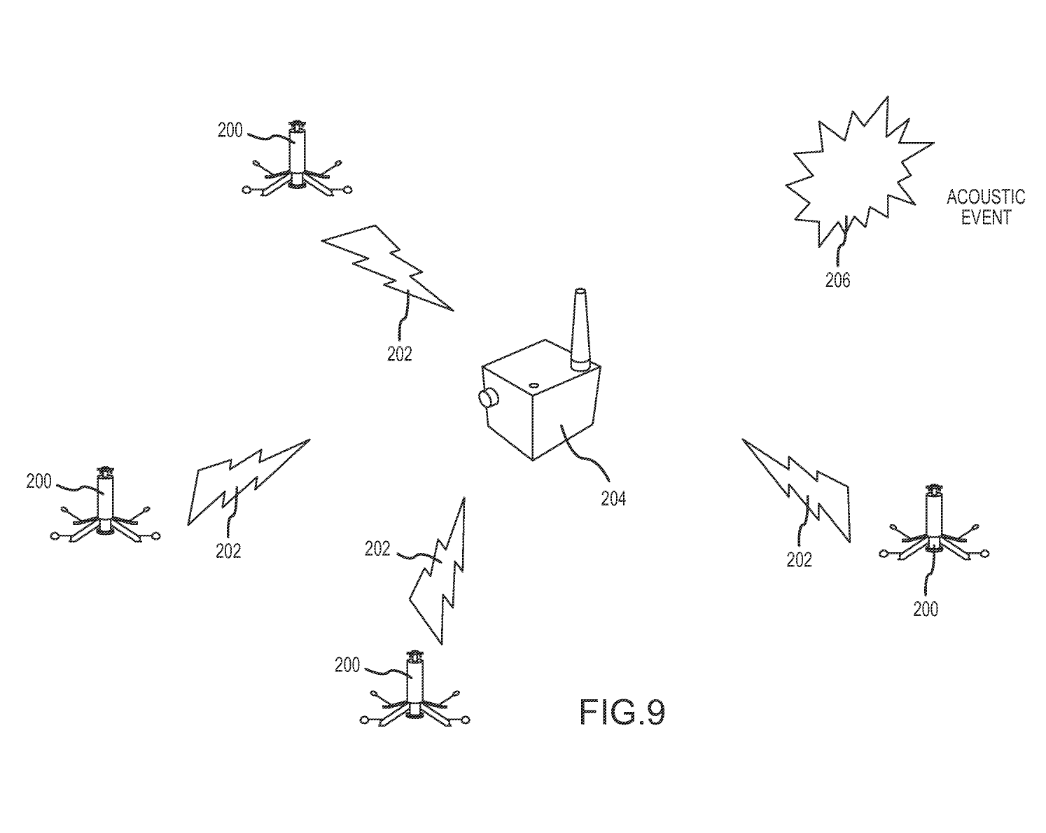

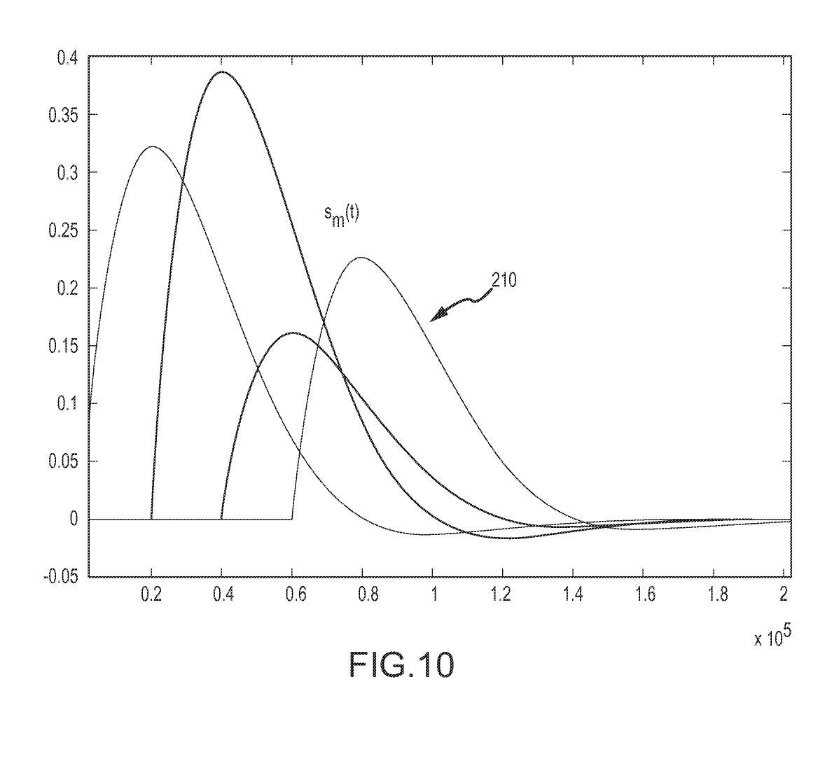

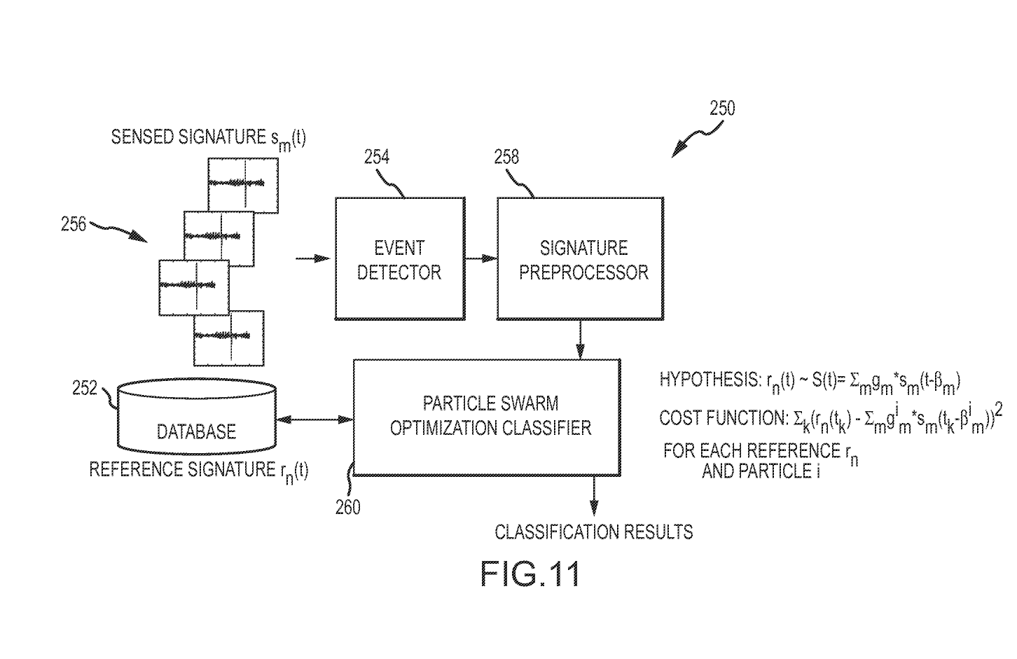

In a fused classification scenario, a plurality of acoustic sensors 200 such as unattended ground sensors (UGS) is distributed within a monitored environment such as shown in FIG. 9. The sensors are connected via a network 202 such as a wireless network to a central processing node 204 such as a ground node, aerial node, manned vehicle, unmanned aerial vehicle or satellite. The central processing node 204 may be one of the acoustic sensors 200. An acoustic event 206 such as an explosion, gun shot etc. is monitored by the networked acoustic sensors that each report a component temporal acoustic signature sₘ(t) to the central processing node. As shown in FIG. 10, the variable distances between the acoustic event and the sensors 200 and other environmental factors (e.g. interference, temperature, humidity) etc. cause the component signatures sₘ(t) 210 to vary in amplitude, temporal shift and time dilation.

The central processing node 204 processes the component signatures sₘ(t) to detect the acoustic event 206 and form a fused acoustic signature S(t)=Σgₘ*sₘ(t−βₘ) over M sensed signatures. Because this is done online in real time the component signatures sₘ(t) are typically not modeled. These sensed component signatures sₘ(t) can be scaled in amplitude with gain parameter gₘ and scaled in time with temporal shift parameter βₘ but are not readily dilated in time. However, testing has shown that the process of fusing multiple component signatures effectively removes the need for the time dilation parameter to fit the sensed acoustic signature to the reference signature using PSO to estimate the gain and shift parameters.

The system and method for applying PSO to fused classification is essentially the same as that for independent classification except for changes to the hypothesis and the cost function and initialization of the particles. In an embodiment of fused classification, the hypothesis is that a reference signature rₙ(t) can be represented over time by a variation of a fused acoustic signature S(t)=Σgₘ*sₘ(t−βₘ) over M sensed signatures in terms of gain and temporal shift. In an embodiment, the cost function for the n^{th} acoustic reference signature is given by Σₖ(rₙ(tₖ)−Σₘgⁱₘ*sₘ(tₖ−βₘ))² over time increment k for each particle i. In an embodiment particle pi=[gⁱ₁, βⁱ₁, gⁱ₂, βⁱ₂, gⁱ₃, βⁱ₃, . . . ]. The classifier computes the cost function for each particle and, assuming the algorithm has not converged or timed out, updates the position and velocities of the swarm of particles according to equations 1 and 2 above.

In an embodiment, a fused classifier 250 comprises a database 252 of reference acoustic signatures associated with different acoustic events; each reference acoustic signature is represented by an exemplar rₙ(t). An acoustic event detector 254 monitors sensed temporal acoustic signatures sₘ(t) 256 from multiple acoustic sensors to detect events. The detector may, for example, estimate the energy (variance of a segment of the temporal acoustic signature of short time segments ˜10-20 msec) and compare the energy value to a threshold; if the energy exceeds the threshold, then an event is detected and stored in memory.

Upon detection of an event, a signature preprocessor 258 windows out that portion of the digitized temporal acoustic signal sₘ(t) about the event time. A classifier 260 fuses the sensed signatures sₘ(t) 256 to form an acoustic signature S(t))=Σgₘ*sₘ(t−βₘ) over M sensed signatures. The classifier comprised of one or more computer processors configured to implement particle swarm optimization (PSO) uses PSO to answer a specific hypothesis (e.g. reference signature rₙ(t) S(t))≅Σgₘ*sₘ(t−βₘ))and to minimize a cost function (e.g. Σₖ(rₙ(tₖ)−Σₘgⁱₘ*sₘ(tₖ−βₘ))²) based on that hypothesis to identify the reference signature rₙ(t) that is the best fit to the sensed data, hence classify the acoustic event.

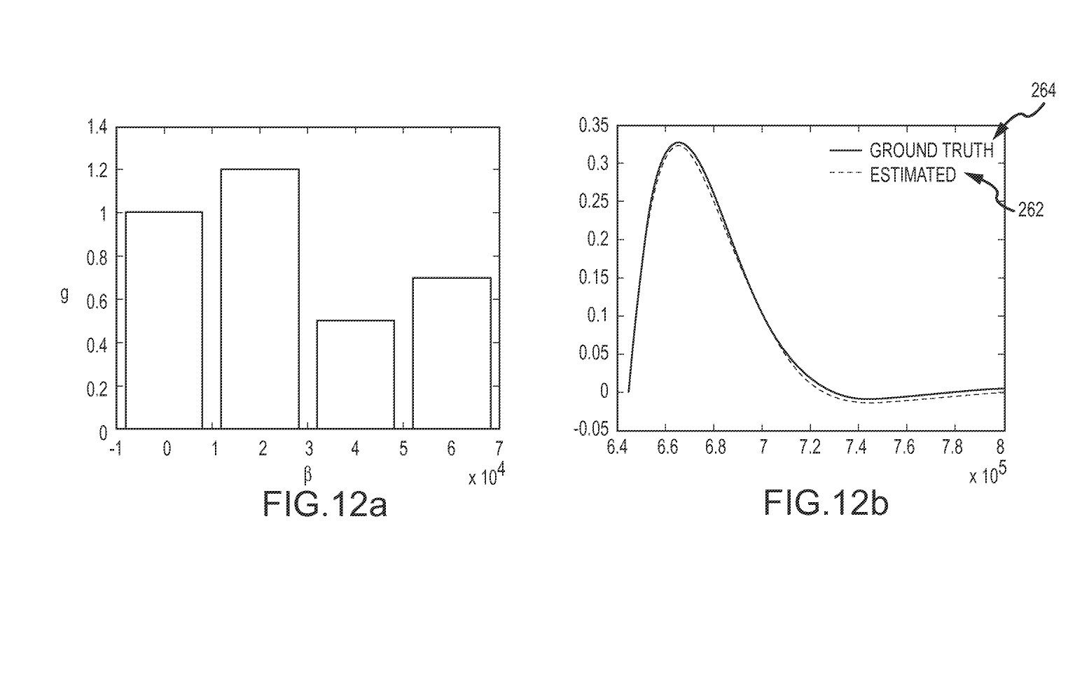

In an embodiment in which four sensed acoustic signatures sₘ(t) are reported to and processed by the fused classifier, the values of optimized gain parameters g and temporal shift parameters β for each of the four components are depicted in FIG. 12a. The resultant fused signature S(t) 262 is depicted with the ground truth signature 264 of the acoustic event in FIG. 12b. The fused Classifier robustly and accurately reproduces the ground truth signature, hence PSO robustly and accurately classifies that signature.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. An acoustic event classifier, comprising:
a database of reference acoustic signatures rₙ(t) associated with different acoustic events;
one or more acoustic sensors that measure a component temporal acoustic signature sₘ(t);
an acoustic event detector that monitors the component temporal acoustic signatures from the one or more acoustic sensors to detect acoustic events; and
a classifier comprising one or more computer processors configured to apply particle swarm optimization (PSO) in which for each of a plurality of said reference acoustic signatures said classifier initializes a swarm of multiple particles with initial values for a variable gain parameter g and a variable temporal shift parameter β and iteratively modifies those values based on parameter values found by that particle and other particles in the swarm to fit the reference acoustic signature rₙ(t) to a temporal acoustic signature S(t) comprised of the one or more component temporal acoustic signatures sₘ(t) until the swarm converges to final parameter values, and selects the acoustic event associated with the reference acoustic signature rₙ(t) having the best fit to the sensed temporal acoustic signature S(t).

2. The acoustic event classifier of claim 1, wherein the acoustic event detector monitors the component temporal acoustic signature from a single acoustic sensor such that S(t) comprises only the component temporal acoustic signature sₘ(t) from that single acoustic sensor.

3. The acoustic event classifier of claim 2, wherein the classifier uses PSO to scale the temporal acoustic signature S(t) according to the gain parameter and shift parameter values to fit S(t) to the reference acoustic signature rₙ(t).

4. The acoustic event classifier of claim 2, wherein each reference acoustic signature rₙ(t) is represented by a temporal model g*rₙ(εt+β) where rₙ(*) is the n^{th} reference acoustic signature of N and ε is a variable time dilation parameter, said classifier using PSO to scale the temporal model according to the gain, shift and time dilation parameter values to fit the model to the temporal acoustic signature S(t).

5. The acoustic event classifier of claim 4, wherein rₙ(*) is modeled as a spline, polynomial or Gabor function.

6. The acoustic event classifier of claim 4, wherein rₙ(*) comprises a plurality of knots to form a piecewise temporal model.

7. The acoustic event classifier of claim 1, wherein the classifier fuses the component temporal acoustic signatures from a plurality of said acoustic signatures sₘ(t) to form the temporal acoustic signature S(t)=Σgₘ*sₘ(t−βₘ) over M component signatures in which each component temporal acoustic signature sₘ(t) is scaled by a variable gain parameter gₘ and a variable temporal shift parameter βₘ, wherein the classifier uses PSO to scale the temporal acoustic signature S(t) according to the gain and temporal shift parameter values for each of the component signatures to fit S(t) to the reference acoustic signature rₙ(t).

8. The acoustic event classifier of claim 1, wherein the acoustic event produces a non-periodic and non-linear component temporal acoustic signature sₘ(t).

9. The acoustic event classifier of claim 1, wherein each particle has a cost function that measures the scaled fit between the reference acoustic signature and the temporal acoustic signature, the gain and temporal shift parameter values that provide the minimum cost function constituting the best-found values, said classifier modifying the gain and temporal shift parameter values for each particle based on the best-found values for that particle and the best-found values for all particles in the swarm through the current iteration.

10. The acoustic event classifier of claim 9, wherein said classifier further modifies the gain and temporal shift parameter values for each particle based on an inertia of that particle.

11. An acoustic event classifier, comprising:
a database of reference acoustic signatures associated with different acoustic events; each reference acoustic signature represented by a temporal model g*rₙ(εt+β) where rₙ(*) is the n^{th} reference acoustic signature of N and g is a variable gain parameter, ε is a variable time dilation parameter and β is variable temporal shift parameter;
an acoustic sensor that measures a temporal acoustic signature S(t);
an acoustic event detector that monitors the temporal acoustic signature S(t) from the acoustic sensors to detect acoustic events; and
a classifier comprising one or more computer processors configured to apply particle swarm optimization (PSO) in which for each of a plurality of said reference acoustic signatures said classifier initializes a swarm of multiple particles with initial values for the variable gain parameter g, the variable time dilation parameter ε and the variable temporal shift parameter β to scale the temporal model rₙ(*) and iteratively modifies those values based on parameter values found by that particle and other particles in the swarm to fit the model to S(t) until the swarm converges to a final solution for the parameter values, and selects the acoustic event associated with the reference acoustic signature having the best fit to the sensed temporal acoustic signature S(t).

12. The acoustic event classifier of claim 11, wherein rₙ(*) is modeled as a spline, polynomial or Gabor function.

13. The acoustic event classifier of claim 11, wherein each particle has a cost function that measures the fit between the scaled reference acoustic signature and the temporal acoustic signature, the gain and temporal shift parameter values that provide the minimum cost function constituting the best-found values, said classifier modifying the gain and temporal shift parameter values for each particle based on the best-found values for that particle and the best-found values for all particles in the swarm through the current iteration.

14. The acoustic event classifier of claim 13, wherein the cost function for the n^{th} reference acoustic signature is given by Σₖ(gⁱ*rₙ(εⁱtₖ+βⁱ)−S(tₖ))² over time increment k for each particle i.

15. An acoustic event classifier, comprising:
a database of reference acoustic signatures rₙ(t) associated with N different acoustic events;
a plurality M of acoustic sensors that each measures a component temporal acoustic signature sₘ(t);
an acoustic event detector that monitors the component temporal acoustic signatures sₘ(t) from the plurality of acoustic sensors acoustic sensors to detect acoustic events; and
a classifier comprising one or more computer processors configured to fuse the plurality of component temporal acoustic signatures s(t) to form a temporal acoustic signature S(t)=Σgₘ*sₘ(t−βₘ) over M component signatures in which each component temporal acoustic signature s(t) is scaled by a variable gain parameter gₘ and a variable temporal shift parameter βₘ and to apply particle swarm optimization (PSO) in which for each of a plurality of said reference acoustic signatures rₙ(t) said classifier initializes a swarm of multiple particles with initial values for the variable gain parameters and the variable temporal shift parameters for the component signatures sₘ(t) and iteratively modifies those values based on parameter values found by that particle and other particles in the swarm to fit S(t) to the reference acoustic signature rₙ(t) until the swarm converges to final parameter values, and selects the acoustic event associated with the reference acoustic signature rₙ(t) having the best fit to the sensed temporal acoustic signature S(t).

16. The acoustic event classifier of claim 15, wherein each particle has a cost function that measures the fit between the reference acoustic signature and the scaled temporal acoustic signature, the gain and temporal shift parameter values that provide the minimum cost function constituting the best-found values, said classifier modifying the gain and temporal shift parameter values for each particle based on the best-found values for that particle and the best-found values for all particles in the swarm through the current iteration.

17. The acoustic event classifier of claim 16, wherein the cost function for the n^{th} acoustic reference signature is given by Σₖ(rₙ(tₖ)−Σₘgⁱₘ*sₘ(tₖ−βⁱₘ))² over time increment k for each particle i.
